(19) United States
(12) Patent Application Publication
(10) Pub. No.: US 2025/0058346 A1
(43) Pub. Date: Feb. 20, 2025

(54) A SYSTEM FOR COATING AN ITEM

(71) Applicant: ELEMENT 10 AB, BORÅS (SE)

(72) Inventors: Emil BRANDT, ALINGSÅS (SE); Martin HOGANDER, SURTE (SE)

(73) Assignee: ELEMENT 10 AB, BORÅS (SE)

(21) Appl. No.: 18/721,377

(22) PCT Filed: Dec. 21, 2022
(86) PCT No.: PCT/SE2022/051215

§ 371 Date: Jun. 18, 2024

(30) Foreign Application Priority Data
Dec. 22, 2021 (SE) 2151595-2

(51) Int. Cl. B05B 16/20; B05B 13/02; B05B 16/60

(52) U.S. Cl. CPC B05B 16/20; B05B 13/0278; B05B 16/60

(57) ABSTRACT

The present disclosure relates to a system for coating an item, where the item for example may be a body part item, such as a footwear, a bag, etc. The system comprises a rotatable support for receiving the item and a nozzle adapted to selectively distribute a liquid coating solution to the item. The system is operated under the control of a control unit, operating the system in a coating phase and a following evaporation phase. The present disclosure also relates to a corresponding method for coating an item.

### TECHNICAL FIELD

The present disclosure relates to a system for coating an item, where the item for example may be a body part item, such as a footwear, a bag, etc. The system comprises a rotatable support for receiving the item and a nozzle adapted to selectively distribute a liquid coating solution to the item. The system is operated under the control of a control unit, operating the system in a coating phase and a following evaporation phase. The present disclosure also relates to a corresponding method for coating an item.

### BACKGROUND

In order to protect footwear or other items from moisture it is quite common to impregnate the footwear with an impregnating agent which will counteract the influence of moisture/water/dirt.

Typically, the impregnating process is carried out by applying an impregnating agent that has been mixed with a liquid solvent in the form of a mineral turpentine or any other form of hydrocarbon distillates, where the mixture is provided in the form of a mist that is created by a spray can nozzle. The mist is directed towards the footwear, such that a layer of the impregnating agent is applied to a surface of the footwear. Once applied, the liquid mineral turpentine solvent will evaporate and leave a water-repellent membrane on the footwear. This process is typically carried out outside, since the liquid mineral turpentine solvent, as well as any excess impregnating agent, has a bad smell, leave stains on the surroundings, and if inhaled is potentially harmful to the health.

That said, it is generally desirable to allow the impregnating process to anyway be performed indoors, such as at a shoe store, in direct relation to sale of the footwear. When performing the impregnating process in an indoor environment, it is for obvious reasons necessary to take care of the liquid mineral turpentine solvent as well as any excess impregnating agent generated during the impregnating process.

A solution to this problem is presented in U.S. Pat. No. 9,498,790, presenting a system for surface treatment of footwear, where the system is intended to be arranged in a shoe store. The footwear is positioned within a chamber, whereafter the footwear is sprayed with the impregnating agent. Once the spraying process has completed, a vacuum is formed within the chamber and the (evaporated) liquid mineral turpentine solvent as well as any excess impregnating agent is sucked out from the chamber and retained within an active carbon filter.

Even though the implementation presented in U.S. Pat. No. 9,498,790 generally solves the problem with expelling the (evaporated) liquid mineral turpentine solvent as well as any excess impregnating agent into a surrounding indoor environment, there is always an endeavor to introduce further improvements. Specifically, there is a desire to minimize the cost of operation of the system used for performing the impregnating process, as well as for ensuring a safer working environment for a user operating such a system.

Further attention is drawn to WO2021204339, presenting a flexible waterproofing/impregnation and drying device and a method of drying items that have undergone a solvent-based or water-based waterproofing/impregnation process. The device presented in WO2021204339 has specifically been configured with inlets for waterproofing/impregnation fluid for waterproofing/impregnating items and one or more heat generating units for effective drying of items, said items being for example clothes, shoes, bags, purses, blankets and garments. Also WO2021204339 present an interesting solution for coating a wearable item. However, the waterproofing scheme employed by WO2021204339 requires a total time for waterproofing/impregnation and drying to be in the range of 15-30 minutes, making it undesirable for instore use.

### SUMMARY

According to an aspect of the present disclosure, the above is at least partly met by a system for coating an item, comprising a coating compartment, a support arranged within an interior of the coating compartment, wherein the support is adapted to receive the item, a reservoir containing a liquid coating solution, the liquid coating solution comprising a coating agent mixed with a liquid biosolvent, and a nozzle connected to the reservoir, arranged within the interior of the coating compartment, and adapted to selectively distribute the liquid coating solution to the item, wherein the system further comprises a control unit adapted to operate the system in a coating phase and a following evaporation phase, an actuator mechanically connected to the nozzle and electrically connected to the control unit, wherein operation of the actuator controls a position of the nozzle relative to the support, and a climate property adjustment arrangement connected to the control unit and adapted to selectively adjust a climate property within the coating compartment, wherein the nozzle is activated by the control unit and distributes the liquid coating solution for at least a portion of the coating phase, a position of the nozzle is adjusted under the control of the control unit relative to the item for at least a portion of the coating phase, and the climate property adjustment arrangement is activated for at least a portion of the evaporation phase.

The present disclosure is based on the understanding that it has been shown beneficial to allow coating of the item within the coating compartment to take place in such a manner that the position of the nozzle that distributes the liquid coating solution is moved relative to the item. The inventors have specifically identified that such a procedure may ensure that the item is coated more evenly as compared to a situation where e.g. one or multiple nozzles are arranged at fixed position relative to the item to be coated.

Furthermore, when performing an impregnating process where the liquid solvent is organic, such as being water, acetals or possibly alcohol, or any other related or similar biosolvents, it has been found that the general approach of simply waiting for a predetermined evaporation time period will not be sufficient for the liquid biosolvent to more or less completely evaporate from the coated item. Accordingly, the inventors have identified that it is desirable to introduce a climate property adjustment arrangement that can be controlled to selectively adjust a climate property within the coating compartment to reduce evaporation time, thereby significantly reducing the time it takes for the liquid biosolvent to evaporate from the item, whereby the item will appear dryer as compared to not making use of the climate property adjustment arrangement. In some embodiments the evaporation phase is between 20-100 seconds, preferably 40-80 seconds.

Biosolvents as defined in relation to the present disclosure should be seen as an alternative to e.g. previously used petrochemical solvents including mineral turpentine or any other form of hydrocarbon distillates. Rather, biosolvents may as indicated above be one of or a mixture of water, acetals alcohol, or e.g. derivatives from processing or fermenting of agricultural crops, materials from the forest industry or general biodegradable solvent products.

This operation will accordingly ensure that the item is perceived as at least essentially dry (at touch) when being removed from the coating compartment. The use of an biosolvent will greatly improve the overall working environment, as well as improving environmental aspects of coating/impregnating an item. Accordingly, the present disclosure provides for an improved coating system that allows for effective coating/impregnation of an item using a liquid coating solution, where a liquid solvent of the liquid coating solution is organic.

Within the context of the present disclosure the expression “item” should be interpreted broadly. Specifically, it should be understood that the item in some embodiment may be a body part item, where a body part item is an item that can be worn by a person or an animal. Examples of body part items include footwear, gloves, hats, jackets, etc. Other items may also be coated using the system according to the present disclosure, for example including bags, a cover for e.g. a boat, etc., thus not necessarily being items worn by a person or an animal, but having a benefit from being coated/impregnated.

As discussed above, it has shown to be beneficial to allow coating of the item within the coating compartment to take place in such a manner that the position of the nozzle that distributes the liquid coating solution is moved relative to the item. This can for example be achieved by arranging the support to be rotatable by means of a thereto connected electrical motor, where the electrical motor typically is connected to and controlled by the control unit. Such an implementation of the relative nozzle-item repositioning can in some embodiments provide for a reliable operation as well as ensuring that the system may be arranged in a compact manner. In some embodiments it has shown beneficial to activate the electrical motor not only during the coating phase by also during at least a portion of the evaporation phase, to thereby reducing a time for evaporating the liquid biosolvent.

That said, it may also be possible and within the scope of the present disclosure to allow the item to be stationary, while the position of the nozzle is adjusted during the coating phase. Such an embodiment may for example be achieved by movably arranging the nozzle at a “track”, or by arranging the nozzle at an “arm”, where the arm is rotated relative to the item.

The climate property adjustment arrangement may in some embodiments comprise at least one of an electrical heating means adapted to increase a temperature within the interior of the coating compartment, and an air circulating arrangement adapted to circulate air within the interior of the coating compartment. In some embodiments it may be beneficial to arrange the climate property adjustment arrangement to comprise both the electrical heating means and the air circulating arrangement.

The electrical heating means may for example comprise a resistive heater, for example provided within an airflow generated by the air circulating arrangement, whereby a heated airflow may be circulated around and towards the item. That said, the electrical heating means could alternatively, or also, include a radiant heater, such as for example an infra based heater. Such a radiant heater could as such be arranged within the coating compartment and facing the item. Also, such a radiant heater is also preferably connected to and controlled by the control unit.

In a preferred embodiment the electrical heating means is controlled by the control unit to keep an average temperature within the coating compartment above a temperature exterior of the compartment during the evaporation phase. Accordingly, an energy consumption of the electrical heating means can be reduced by taking into account knowledge of the temperature exterior of the compartment, meaning that less energy may be used in case the coating system is arranged at a place where the temperature exterior of the compartment is relatively high. That said, in some embodiments it may be beneficial to increase the temperature within the compartment to around 50 degrees C. for at least a portion of the evaporation phase, thereby significantly reducing the time spent for evaporating the liquid biosolvent.

Generally, the complete process including the coating phase and the evaporation phase is performed in such a manner that the item remains within a single coating compartment throughout the complete process. However, in an alternative embodiment the coating compartment is divided into two parts or provided separately, allowing the coating phase to be performed in one coating compartment portion and the evaporation phase in another separate coating compartment portion. Such an alternative embodiment may have advantages when it comes to optimizing the portions to the process taking place within the specific coating compartment portion. For example, the size of the different coating compartment portions may be selected to be optimized for the respective phases (i.e. the coating and the evaporation phase).

Preferably the coating system further comprises an air duct having a first opening connecting the air duct with an interior of the coating compartment at a first position of the coating compartment, where a second opening connects the air duct with the interior of the coating compartment at a second position of the coating compartment, the second position being different from the first position. Accordingly, the airflow generated by the air circulating arrangement will truly circulate the air from one end to another end of the compartment. In some embodiments the air circulating arrangement comprises a fan and a filter. It may in some embodiments be desirable to change the filter at regular intervals to increase an operational lifetime of the fan.

In some embodiments, the air circulating arrangement is configured to force air from within the interior of the coating compartment into the air duct. Accordingly, air is not sucked out of the compartment but rather pushed out of the compartment. However, it could of course also be possible to arrange the air circulating arrangement to such air out of the compartment. The different embodiments have different advantages dependent on the implementation at hand.

Preferably, the air circulating arrangement is (also) activated for at least a portion of the coating phase. Such an implementation may allow for a further improvement as to the distribution of the liquid coating solution during the coating phase. Specifically, the air circulating arrangement may be arranged to direct a mist or similar formed at the nozzle towards the item to be coated. For example, the system may in some embodiments be provided with a directing portion arranged within the coating compartment and arranged to direct an air flow generated by the air circulating arrangement towards the item.

Taking the above into account, it may in some embodiments be desirable to arrange the air circulating arrangement to generate a first air volume flow during the coating phase and a second air volume flow during the evaporation phase, the first air volume flow being (substantially) lower than the second air flow volume.

As discussed above, the reservoir contains the liquid coating solution and the nozzle is connected to the reservoir, such as using some form of tubing or pipe. The liquid coating solution can in some embodiments be “pumped” (e.g. using an electrical pump) from the reservoir and “pushed” through the nozzle to form the above discussed mist of the liquid coating solution to be used for coating the item. However, it may in some embodiments be beneficial to instead provide the system with an air tank holding compressed air, where the air tank is connected to the reservoir and provided for atomizing the liquid coating solution using the nozzle. The air tank may in some embodiments be filled using a compressor. However, it could also be possible and within the scope of the present disclosure to provide a standalone air tank that is changed with regular intervals. Such a standalone air tank could potentially provide for a quieter coating system, due to the lack of the compressor. However, using a standalone air tank could at the same time increase servicing intervals for the coating system.

Control of when the nozzle it to distribute the atomized liquid coating solution could for example be achieved by arranging the coating system to further comprise a valve connected to the control unit and electrically controllable for selectively distributing the liquid coating solution to the item. Dosing of the atomized liquid coating solution may in such an embodiment be precise, reducing operational cost and possibly the time needed for coating and evaporation.

Preferably, the coating compartment comprises an access door configured to selectively allow access to the interior of the coating compartment. This of course simplifies the operational process of coating the item. However, it may generally be desirable to ensure that the coating compartment is only accessible outside of the coating and the evaporation phase. Accordingly, e.g. an electronic lock provided in relation to the access door may be arranged to be controlled by the control unit.

Furthermore, it may be desirable to equip the coating system with a control panel arranged external of the coating compartment, connected to the control unit, and arranged to allow a user to operate the system for coating and drying the item. The control panel may for example be provided with a user interface to allowing the user to select a type of item, where the control unit subsequently may operate a specifically selected “coating recipe” targeted for a specific type of item. Accordingly, in some embodiments the control unit stores a plurality of different individual coating recipes relating to different item or item types.

According to another aspect of the present disclosure there is provided a method for operating a system arranged for coating an item, wherein the system comprises a coating compartment, a support arranged within an interior of the coating compartment, a reservoir containing a liquid coating solution, the liquid coating solution comprising a coating agent mixed with a liquid biosolvent, and a nozzle connected to the reservoir, arranged within the interior of the coating compartment, and adapted to selectively distribute the liquid coating solution to the item, wherein the method comprises the steps of receiving the item at the support, operating, using the control unit, system in a coating phase, wherein the coating phase comprises rotating, under the control of the control unit. the support with a predefined rotational speed, distributes the liquid coating solution for at least a portion of the coating phase using the nozzle and under control of the control unit, and adjusting a portion of the under the control of the control unit relative to the item for at least a portion of the coating phase, and operating, using the control unit, system in an evaporation phase, wherein the evaporation phase comprises operating the climate property adjustment arrangement is activated for at least a portion of the evaporation phase. This aspect of the present disclosure presents similar advantages as the previous aspect of the present disclosure and discussed above.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 illustrates an exemplary system for coating an item according to a currently preferred embodiment of the present disclosure, and

FIG. 2 shows a flow chart of a method for operating the coating system according to the present disclosure.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness to fully convey the scope of the present disclosure to the skilled addressee. Like reference characters refer to like elements throughout.

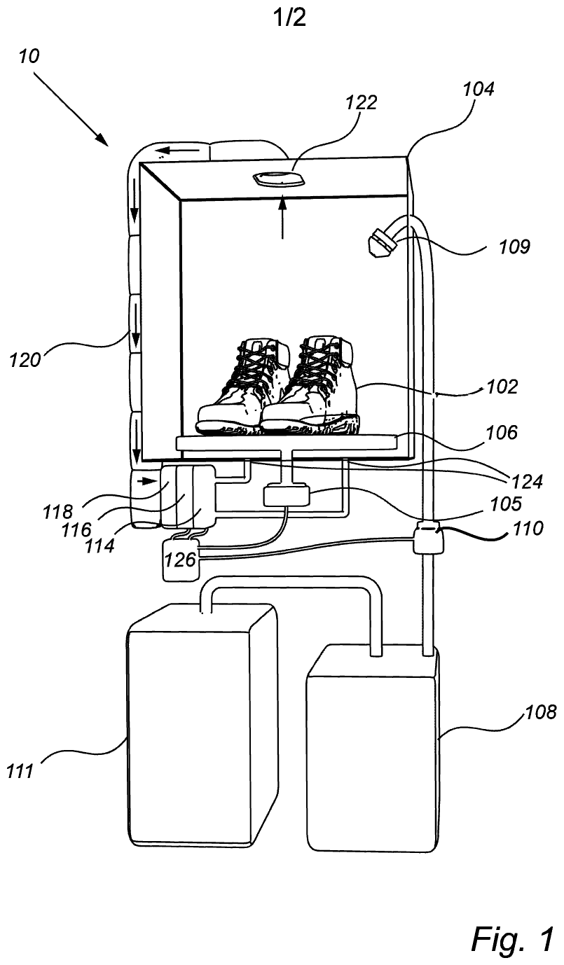

Referring now to the drawings and to FIG. 1 in particular, conceptually depicting a coating system 10 for coating an item, here in the form of a pair of shoes 100. In the example as is shown in FIG. 1, the coating system 10 is a specifically adapted for forming an impregnating layer of at a surface of the shoe 100. It is of course possible to make use of the coating system 10 for providing other types of coatings to a multitude of different items. As mentioned above, such other types of items can for example include body part items, such as gloves, jackets, etc., and/or general items such as bags.

The coating system 10 comprises a coating compartment 104, where the shoes 100 are to be coated at an interior of the coating compartment 104. A support 102 is also provided, onto which the shoes 100 are to be placed during coating. A door (not shown) may be provided for allowing access to the interior of the coating compartment 104.

As is illustrated in FIG. 1, the support 102 is provided as a “disc” arranged at an axis. The axis is in turn connected to an electrical motor 105. Activation of the electrical motor 105 will rotate the axis and the disc 102, where the disc/support 102 will rotate similar to a turntable.

The coating system 10 also comprises a reservoir 108 containing a liquid coating solution and a nozzle 109 connected to the reservoir 108, where the nozzle 109 is arranged within the interior of the coating compartment 104 and adapted to selectively distribute the liquid coating solution to the shoes 100, by controlling a valve 110. The coating system further comprises an actuator (not explicitly shown) mechanically connected to the nozzle 109 and arranged for adjusting the position of the nozzle relative to an interior of the coating compartment 104. The actuator may preferably be a rotary actuator, such as for example a servo.

The coating system 10 also comprises a pressurizing arrangement 111. The pressurizing arrangement 111 can for example include an air tank holding compressed air, or a compressor. The valve 110 is in one embodiment an electrically controllable valve. Other types of controllable valves are however also possible and within the scope of the present disclosure.

The coating system 10 further comprises a climate property adjustment arrangement and provided for selectively adjust a climate property within the coating compartment. In the illustration provided in FIG. 1, the climate property adjustment arrangement is arranged to comprise three parts, namely a heater 114 arranged to increase a temperature within the interior of the coating compartment 104, a fan 116 for circulating air within the interior of the coating compartment 104, and a filter 118.

For circulating air within the interior of the coating compartment 104, it is desirable, but not necessary to include an air duct 120. The overall air duct 120 is in FIG. 1 at a first end connected to a first 122 opening into the interior of the coating compartment 104. A second end of the overall air duct 120 is connected to a second opening 124 into the interior of the coating compartment 104. In FIG. 1, the coating compartment 104 is provided with dual second openings 124. In the illustration provided in FIG. 1, the first opening 122 is provided at a “roof section” of the coating compartment 104, whereas the second opening 124 is provided at a “floor section” of the coating compartment 104.

The climate property adjustment arrangement is as shown in FIG. 1 arranged intermediate the air duct 120, whereby air is allowed to travel through the climate property adjustment arrangement. The position of the climate property adjustment arrangement must not necessarily be positioned as is exemplified in FIG. 1. Rather, the climate property adjustment arrangement can be arranged in direct conjunction with the first 122 or the second 124 opening. Furthermore, the parts of the climate property adjustment arrangement must not necessarily be arranged together as is shown in FIG. 1. Rather, it is possible to e.g. space them apart or just keep some of the parts together. Furthermore, it may in line with the present disclosure be possible to omit some of the parts of the climate property adjustment arrangement, such as omitting the heater 114, the fan 116 or filter 118. Still further, e.g. the heater 114 could be arranged within the interior of the coating compartment 104, by including e.g. an infrared heater or similar within the coating compartment 104, such as at the roof section of the coating compartment 104.

It should be noted that the fan 116 can be arranged to generate an air flow in either of two directions. Accordingly, the fan 116 can be seen as “sucking” air out of the coating compartment 104 or “pushing” air into the coating compartment 104. Either way, air will flow through the coating compartment 104 and the air duct 120.

The general operation of the coating system 10 is handled by a control unit 126. The control unit 126 is typically electrically connected to and arranged to control the electrical motor 105, the valve 110, the electrical heater 114 and the fan 116. It may alternatively be possible to connect at least some of the listed devices to the control unit 126 by wireless means, such as e.g. using a Bluetooth, Z-wave, Zigbee or similar connection.

It may also be possible to include one or a plurality of sensors (not shown) with the coating system 10, where such sensors are connected to the control unit 126. For example, it may be possible to arrange a temperature/humidity sensor within the interior of the coating compartment 104, pressure sensors in relation to the pressurizing arrangement 111 and/or the reservoir 108. A sensor may also be provided at the door to the coating compartment 104, allowing the control unit 126 to detect if the door is open or closed. Accordingly, such sensors may then be used by the control unit 126 during operation.

The control unit 126 may also be connected to a control panel (not shown), where the control panel typically is arranged externally of the coating compartment 104. Such a control panel may be used by an operator to control the coating system 10 to coat the shoes 102. In some embodiments the control panel may be electrically connected to the control unit 126. However, the control panel could possibly be provided in the form of a “remote control”, wirelessly connected to the control unit 126.

The control unit 126 may in some embodiments be a general-purpose processor, an application specific processor, a circuit containing processing components, a group of distributed processing components, a group of distributed computers configured for processing, etc. The processor may be or include any number of hardware components for conducting data or signal processing or for executing computer code stored in memory.

The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor, e.g., via a circuit or any other wired, wireless, or network connection.

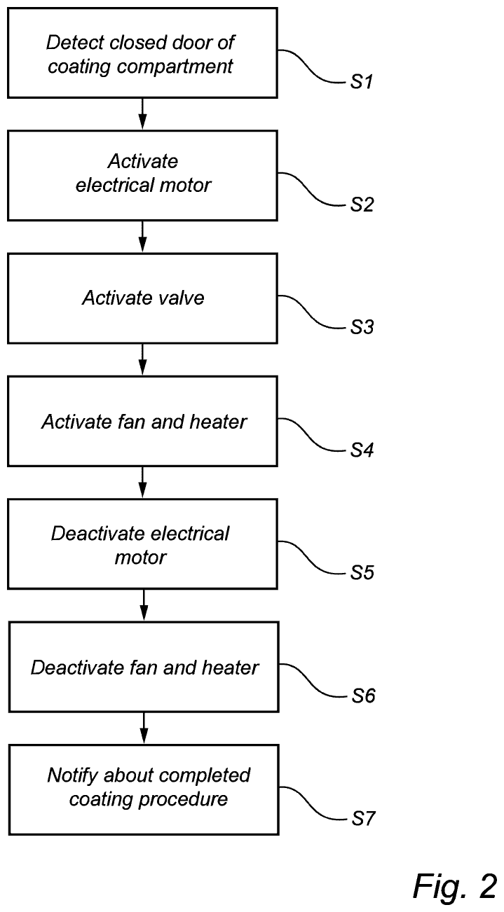

During operation of the coating system 10, with further reference to FIG. 2, the operator will open the door provided at the coating compartment 104 and position the shoes 102 at the structure/disc 106. The operator will then close the door and by means of the control panel initiate the coating procedure. It may in some embodiments be possible to allow the operator to input what type of item that is to be coated, where this information of item type will be used in the coating procedure.

Once the door to the coating compartment 104 is detected, S1, to be closed, the control unit 126 will activate, S2 the electrical motor 105 to start rotating the structure/disc 106. It may here be optionally possible to lock the door.

The rotational speed of the structure/disc 106 may for example be dependent on the item type, where e.g. a boot may have a slower rotational speed as compared to a low dress shoe. In some embodiments the rotational speed of the structure/disc 106 is exemplified to be within the range of 1-100 rpm. In a preferred embodiment the rotational speed is 60-120 degrees per second and with at least two complete rotations. An acceleration/retardation of the structure/disc 106 may also be dependent on the type of the item.

At this point the control unit 126 will activate, S3, the valve 105 to start the liquid coating solution to flow from the reservoir 108, through a conduit connecting the reservoir 108 and the nozzle 109, and out through the nozzle 109. Since the liquid coating solution in the presented embodiment is pressurized, the nozzle 109 will form a mist of the liquid coating solution that is directed towards the shoes 102, such that the shoes 102 will be coated with a “thin film” of the liquid coating solution at an outer surface of the shoes 102. In one embodiment the valve 105 is operated for 1-5 seconds. The operating time for the valve 105 may possibly be dependent on the type of the item, where e.g. a larger item will result in a longer operating time, as compared to what is needed/used for an in comparison smaller item. It may be possible to activate the valve 105 for more than a single time, such as by activating the valve 105 in a plurality of shorter bursts. In some embodiments it may be possible to activate the valve 105 e.g. 2-5 times.

In a preferred embodiment the actuator is arranged to adjust an angle of the nozzle 109 during the coating phase. As such, the nozzle 109 may be arranged in a first direction towards the rotational direction of the disc 106, followed by a redirection of the angle of the nozzle 109 in a direction following the rotational direction of the disc 106. The angular regulation of the nozzle 109, using the actuator, may for example be between 30-60 degrees.

By rearranging the nozzle 109 as discussed above it may be possible to improve coverage of the liquid coating solution at the item within all areas of the item. That is, the coverage of the liquid coating solution will be in comparison higher as to when the nozzle is constantly arranged in a fixed angle relative to the disc 106.

In a preferred embodiment the coating time includes two rotations of the disc 106, where the nozzle 109 is rearranged as discussed above after the first rotation. The total time for the coating phase may in some embodiments, depending on the item type, be around 60-70 seconds.

After a first waiting time, such as 5-10 seconds, where possibly the fan 116 is activated, the coating phase of the coating procedure is considered finalized and now the evaporation phase of the coating procedure is initialized. At this point the control unit 126 will activate, S4, the fan 116 and the heater 114. The fan 116 will as such push a heated air flow into the bottom end of the coating compartment 104, at the second opening 124 into the coating compartment 104. The activation of the fan 116 and the heater 114 will speed up the evaporation of the liquid biosolvent comprised with the liquid coating solution. The coating agent comprised with the liquid coating solution will remain at the shoes 102.

The electrical motor 105 may continue to spin the structure/disc 106, possibly at a reduced rotational speed as compared to the rotational speed used during the coating phase. It may however be possible to deactivate, S5, the electrical motor 105 such that the rotation of the structure/disc 106 stops.

The evaporation phase generally proceeds for a duration of e.g. 20-100 seconds, preferably 40-80 seconds. Once this time has lapsed, the control unit 126 will deactivate, S6, the fan 116 and the heater 114. At this time also the rotation of the structure/disc 106 should have stopped. The operator will at this stage be notified, S7, that the coating procedure is finalized. The operator will then again be given access to the shoes 102 through the door.

In summary, the present disclosure relates to a system for coating an item, comprising a coating compartment, a support arranged within an interior of the coating compartment, wherein the support is adapted to receive the item, a reservoir containing a liquid coating solution, the liquid coating solution comprising a coating agent mixed with a liquid biosolvent, and a nozzle connected to the reservoir, arranged within the interior of the coating compartment, and adapted to selectively distribute the liquid coating solution to the item, wherein the system further comprises a control unit adapted to operate the system in a coating phase and a following evaporation phase, an actuator mechanically connected to the nozzle and electrically connected to the control unit, wherein operation of the actuator controls a position of the nozzle relative to the support, and a climate property adjustment arrangement connected to the control unit and adapted to selectively adjust a climate property within the coating compartment, wherein the nozzle is activated by the control unit and distributes the liquid coating solution for at least a portion of the coating phase, a position of the nozzle is adjusted under the control of the control unit relative to the item for at least a portion of the coating phase, and the climate property adjustment arrangement is activated for at least a portion of the evaporation phase.

The use of an biosolvent will greatly improve the overall working environment, as well as improving environmental aspects of coating/impregnating an item. Accordingly, the present disclosure provides for an improved coating system that allows for effective coating/impregnation of an item using a liquid coating solution, where a liquid solvent of the liquid coating solution is organic.

In addition, the control functionality of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art. Further, a single unit may perform the functions of several means recited in the claims. In the claims, any reference signs placed between parentheses shall not be construed as limiting to the claim. Furthermore, in the claims, the word “comprising” does not exclude other elements or steps, and the indefinite article “a” or “an” does not exclude a plurality.

Variations to the disclosed embodiments can be understood and effected by the skilled addressee in practicing the claimed present disclosure, from a study of the drawings, the disclosure, and the appended claims. The person skilled in the art realizes that the present disclosure is not limited to the preferred embodiments.

1. A system for coating an item, comprising:
a coating compartment,
a support arranged within an interior of the coating compartment, wherein the support is adapted to receive the item,
a reservoir containing a liquid coating solution, the liquid coating solution comprising a coating agent mixed with a liquid biosolvent, and
a nozzle connected to the reservoir, arranged within the interior of the coating compartment, and adapted to selectively distribute the liquid coating solution to the item, wherein the system further comprises:
a control unit adapted to operate the system in a coating phase and a following evaporation phase,
an actuator mechanically connected to the nozzle and electrically connected to the control unit, wherein operation of the actuator controls a position of the nozzle relative to the support, and
a climate property adjustment arrangement connected to the control unit and adapted to selectively adjust a climate property within the coating compartment, wherein:
the nozzle is activated by the control unit and distributes the liquid coating solution for at least a portion of the coating phase,
a position of the nozzle is adjusted under the control of the control unit relative to the item for at least a portion of the coating phase, and
the climate property adjustment arrangement is activated for at least a portion of the evaporation phase.

2. The system according to claim 1, wherein the climate property adjustment arrangement comprises at least one of:
an electrical heating means adapted to increase a temperature within the interior of the coating compartment, and
an air circulating arrangement adapted to circulate air within the interior of the coating compartment.

3. The system according to claim 1, wherein the support is rotatable by means of a thereto connected electrical motor.

4. The system according to claim 1, wherein the item is stationary, and the position of the nozzle is adjusted during the coating phase.

5. The system according to claim 1, further comprising:
an air duct having a first end connecting the air duct with an interior of the coating compartment at a first position of the coating compartment.

6. The system according to claim 5, wherein the air duct has a second end connecting the air duct with the interior of the coating compartment at a second position of the coating compartment, the second position being different from the first position.

7. The system according to claim 2, wherein the climate property adjustment arrangement comprises the electrical heating means and the air circulating arrangement, and the electrical heating means is arranged in conjunction with the air circulating arrangement for circulating heated air within the interior of the coating compartment.

8. The system according to claim 5, wherein the air circulating arrangement is configured to force air from within the interior of the coating compartment into the air duct.

9. The system according to claim 2, wherein the air circulating arrangement is activated for at least a portion of the coating phase.

10. The system according to claim 7, wherein the air circulating arrangement generates a first air volume flow during the coating phase and a second air volume flow during the evaporation phase, the first air volume flow being lower than the second air flow volume.

11. The system according to claim 2, wherein the electrical motor is activated for at least a portion of the evaporation phase.

12. The system according to claim 1, wherein the item is a body part item or a bag.

13. (canceled)

14. The system according to claim 1, further comprising an air tank holding compressed air, wherein the air tank is connected to the reservoir and provided for atomizing the liquid coating solution using the nozzle.

15. The system according to claim 14, further comprising a valve connected to the control unit and electrically controllable for selectively distributing the liquid coating solution to the item.

16. The system according to claim 1, wherein the liquid biosolvent comprises at least one of water and alcohol.

17. The system according to claim 2, wherein the electrical heating means is controlled by the control unit to keep an average temperature within the coating compartment above a temperature exterior of the compartment during the evaporation phase.

18. The system according to claim 2, wherein the air circulating arrangement comprises a fan and a filter.

19. The system according to claim 2, further comprises at least one air directing portion arranged within the coating compartment and arranged to direct an air flow generated by the air circulating arrangement towards the item.

20. The system according to claim 1, wherein the evaporation phase is between 20-100 seconds.

21-23. (canceled)

24. A method operating a system arranged for coating an item, wherein the system comprises:
a coating compartment,
a support arranged within an interior of the coating compartment, a reservoir containing a liquid coating solution, the liquid coating solution comprising a coating agent mixed with a liquid biosolvent, and
a nozzle connected to the reservoir, arranged within the interior of the coating compartment, and adapted to selectively distribute the liquid coating solution to the item, wherein the method comprises:
receiving the item at the support,
operating, using the control unit, system in a coating phase, wherein the coating phase comprises:
rotating, under the control of the control unit. the support with a predefined rotational speed,
distributes the liquid coating solution for at least a portion of the coating phase using the nozzle and under control of the control unit, and
adjusting a portion of the under the control of the control unit relative to the item for at least a portion of the coating phase, and
operating, using the control unit, system in an evaporation phase, wherein the evaporation phase comprises:
operating the climate property adjustment arrangement is activated for at least a portion of the evaporation phase.
